(19) United States
(12) Patent Application Publication
(10) Pub. No.: US 2024/0160993 A1
(43) Pub. Date: May 16, 2024

(54) MULTIPLE MECHANISMS FOR CIRCUIT CHECKPOINTS

(71) Applicant: Dell Products L.P., Round Rock, TX (US)

(72) Inventors: Victor Fong, Medford, MA (US); Brendan Burns Healy, Haddonfield, NJ (US); Benjamin E. Santaus, Somerville, MA (US)

(21) Appl. No.: 18/345,313

(22) Filed: Jun. 30, 2023

Related U.S. Application Data
(60) Provisional application No. 63/383,345, filed on Nov. 11, 2022.

(51) Int. Cl. G06N 10/80; G06N 10/20

(52) U.S. Cl. CPC G06N 10/80; G06N 10/20

(57) ABSTRACT

One example method includes defining a quantum circuit, orchestrating the quantum circuit to a computing infrastructure for execution, executing the quantum circuit on the infrastructure and, while the quantum circuit is being executed, checkpointing the quantum circuit. One or more of the defining, executing, and checkpointing, includes using a mechanism that improves and/or enhances performance of the checkpointing. Example mechanisms include including a custom gate in the quantum circuit, using quantization when storing state data concerning the quantum circuit, using persistent memory and orchestration for the checkpointing, dynamically determining when checkpointing will be performed, and performing automated flattening of quantum circuit checkpoint images.

### FIELD OF THE INVENTION

Embodiments of the present invention generally relate to quantum computing. More particularly, at least some embodiments of the invention relate to systems, hardware, software, computer-readable media, and methods, for the implementation and use of mechanisms for quantum circuit checkpoints.

### BACKGROUND

Quantum circuit checkpointing, such as tracking the runtime behavior of circuit execution, is useful and offers savings in computational resources and time. However, checkpointing introduces costs of its own.

For example, circuit checkpointing is expensive both in terms of the storage capacity it typically requires, and in terms of the time it takes for IOs (input/output operations). In ideal circumstances, a checkpoint might be taken after execution of each circuit gate, similar to the way in which a checkpoint is taken after execution of each command in a process for building container images. In fact however, the storage and time required to take the checkpoint would likely be prohibitive.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying Figures.

FIG. 1 discloses an architecture according to one example embodiment.

FIG. 2 discloses a method according to one example embodiment.

FIG. 3 discloses an example computing entity configured and operable to perform any of the disclosed methods, processes, and operations.

### DETAILED DESCRIPTION OF SOME EXAMPLE EMBODIMENTS

Embodiments of the present invention generally relate to quantum computing. More particularly, at least some embodiments of the invention relate to systems, hardware, software, computer-readable media, and methods, for the implementation and use of mechanisms for quantum circuit checkpoints. As used herein, a ‘mechanism’ may include, but is not limited to, methods, processes, and operations, as well as modules for performing any of these.

In general, some example embodiments of the invention comprise mechanisms for improving various aspects of quantum circuit checkpointing processes and operations, and other processes and operations, such as may be performed in connection with the execution of quantum circuits on a quantum computing infrastructure, and/or the simulated execution of quantum circuits on a classical computing infrastructure. That is, an embodiment of the invention may be applicable to a simulated execution of a quantum circuit on a classical computing infrastructure, and an embodiment of the invention may be applicable to execution of a quantum circuit on a quantum computing infrastructure. Any one or more of such mechanisms may be combined together in a single embodiment. Following are some examples of such mechanisms.

In an embodiment, call-back gates may be provided in a quantum circuit. These call-back gates may enable the implementation of platform and developer functionalities during execution of the quantum circuit. In an embodiment, quantization may be employed when storing information about the state of a circuit execution. In an embodiment, a circuit checkpointing process may use persistent memory and orchestration. In an embodiment, platform automation may be implemented to dynamically determine where, in a quantum circuit, to checkpoint. In an embodiment, automated flattening of circuit checkpoint images may be implemented.

Further information concerning one or more example embodiments of the invention is disclosed in Appendix A hereto. Appendix A forms a part of this disclosure and is incorporated herein in its entirety by this reference.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that various callback functionalities may be implemented in connection with the execution of a quantum circuit. An embodiment of the invention may operate to reduce disk space requirements when storing state information concerning a circuit. An embodiment may reduce disk writes needed for writing state vectors. An embodiment may operate to dynamically determine when checkpointing will be performed. An embodiment may provide automated flattening of checkpoint images to save time, and storage space. Various other advantages of one or more embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. General Aspects of Some Example Embodiments

Although checkpointing during circuit execution is useful and offers savings in computational resources and time, it comes at its own cost. One of more embodiments of the invention thus provide additional mechanisms to further improve the circuit checkpoint innovations. An embodiment may include any one or more of the following mechanisms:
1. call-back gates for platform and developer functionalities;
2. use of quantization when storing states;
3. persistent memory usage and orchestration for circuit checkpointing;
4. platform automation to dynamically determine where to checkpoint; and
5. automated flattening of circuit checkpoint images.

### B. Aspects of an Example Architecture

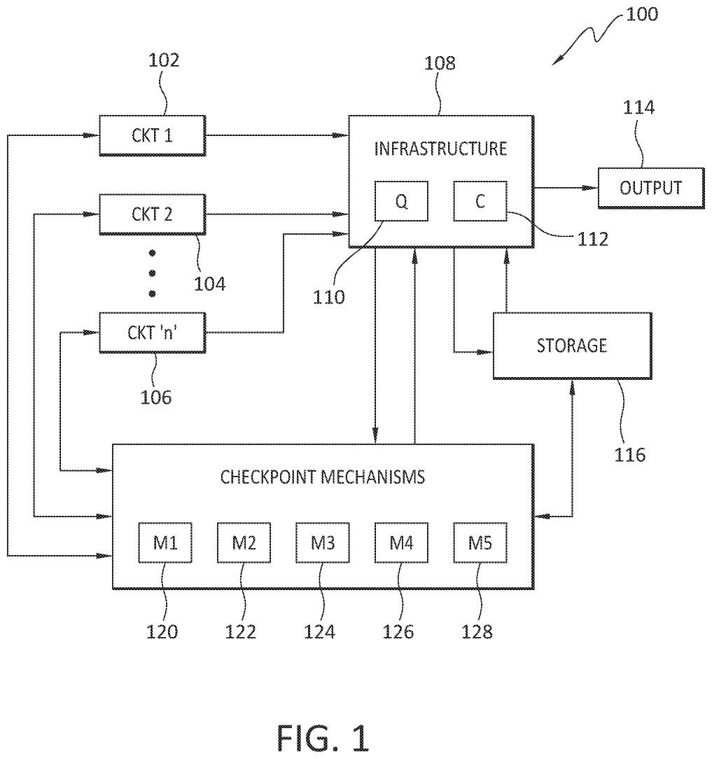

With attention now to FIG. 1, an example architecture according to one embodiment is generally identified at 100. The architecture 100 may comprise one or more circuits 102, 104, and 106, such as quantum circuits for example. Any number ‘n’ of circuits may be provided, where ‘n’ is any integer equal to, or greater, than one. Any of the circuits 102, 104 and 106 may be run on an infrastructure 108. The infrastructure 108 may comprise a quantum computing infrastructure 110 and/or a classical computing infrastructure 112. In an embodiment, a circuit 102, for example, may be executed on the quantum computing infrastructure 110, and the execution of another circuit, such as circuit 106 for example, simulated on the classical computing infrastructure 112. Various outputs 114 may be generated as a result of the execution of one or more circuits.

As a circuit, such as circuit 102, 104, or 106, for example, is executing on the infrastructure 108, state information, such as in the form of one or more state vectors for example, may be stored in, and retrieved from, storage 116. Various other information, data, and metadata, concerning the circuits and their execution on the infrastructure 108 may also be stored in, and retrieved from, storage 116.

Checkpointing processes may be used to determine, and evaluate, the state of a circuit as it is being executed. As another example, checkpointing processes may help to determine whether or not a circuit is executing as expected, and may help to identify problems relating to the execution of the circuit. Some example embodiments of the invention are directed to various mechanisms that may form a part of, and/or be performed in connection with, one or more checkpointing processes.

For example, and with continued reference to FIG. 1, various mechanisms 118 according to one or more embodiments may be provided. Any one or more of the mechanisms 118, in any combination, may be implemented in a given environment and/or with respect to a particular circuit and/or circuit execution process. A mechanism 118 may be performed automatically, and/or may be invoked. A mechanism 118 may be employed at any stage of a circuit construction process and/or circuit execution process. A mechanism 118 may affect the construction and/or the execution of a circuit.

In the example of FIG. 1, various mechanisms 118 may be employed in one or more embodiments of the invention. These mechanisms 118 may include, but are not limited to: [1] 120— callback gates for platform and developer functionalities; [2] 122— use of quantization when storing circuit states; [3] 124— persistent memory usage and orchestration for circuit checkpointing; [4] 126— platform automation to dynamically determine when to checkpoint; and [5] 128— automated flattening of circuit checkpoint images. Any, of these mechanisms may be employed in connection with a particular quantum circuit execution process, although none are required to be employed. Further details concerning each of these mechanisms are provided below.

### C. Detailed Discussion

C.1 Callback Gates

Some aspects of example embodiments of the invention, any or all of which may be implemented in the example architecture 100, concern call back gates for platform and developer functionalities. QPUs (quantum processing units) are currently closed-box design. As a result, developers and administrators may have difficulty in determining the internal operations of the QPUs once circuits start executing, and developers and administrators also lack the ability to introduce platform-level or dynamic behavior.

Thus, an example embodiment of the invention provides for the creation and use of a custom gate that developers can insert into their quantum circuits, such as the circuits 102, 104, and 106 for example. While executing a quantum circuit with QPUs of a quantum computing infrastructure such as the quantum computing infrastructure 110, a control processor may determine when the gate has been executed, and then invoke callback behavior to a classical computing infrastructure, such as the classical computing infrastructure 112 for example. In effect then, execution of the custom gate may invoke the performance of one or more functions relating to the circuit and/or to the execution of the circuit.

While executing a circuit using vQPUs (virtual QPU) on a classical computing infrastructure, a simulation engine, which may be an element of the infrastructure 108, may also invoke callback behavior when the gate needs to be executed. Call back behavior may include, but is not limited to, checkpointing, telemetry collection, or a simple acknowledgement to a classical computing infrastructure that execution of the circuit has reached a certain point. Such embodiments may be particularly useful when conditions and loops are introduced into circuits, so that runtime behavior of circuit execution can be tracked.

C.2 Quantization when Storing Circuit States

Another aspect of some example embodiments concerns the use of quantization when storing states, that is, states of the execution of a quantum circuit, whether on a classical computing infrastructure 112, or on a quantum computing infrastructure. As used herein, ‘quantization’ includes mapping values from a large set of values, to values of a smaller set of values. In this way, important parameters and aspects of the large dataset may be preserved, while reducing storage and other requirements that would otherwise be associated with the handling and storage of the large dataset.

In an embodiment, the state of a quantum circuit may be expressed in the form of a vector, which may also be referred to herein as a ‘state vector,’ that represents the quantum state of all the qubit combinations of the circuit. This state vector may then be written to memory/storage. Because a state vector may be quite large in size, it may consume significant storage space.

Particularly, when storing circuit states beyond the termination of the execution of the circuit, the storage requirement for the state information may be considerable, particularly for high qubit circuits. In such a case, an embodiment may provide a flag that may trigger a mechanism to reduce the disk space requirements imposed by the expected, or actual, storage of state information such as state vectors. One example of such a mechanism is disclosed in Appendix A hereto. In an embodiment, some metadata concerning the state information be stored along with, or as an alternative to, the state information. Such metadata may concern, for example, the binning of the state data.

C.3 Persistent Memory Usage and Orchestration for Circuit Checkpointing

Still another aspect of some example embodiments concerns persistent memory usage and orchestration for circuit checkpointing. In particular, most of the cost in performing a checkpointing process may come from the time required to write the state vector to memory. If the circuit is being run using, at least in part, persistent memory, then the checkpointing may be performed without as much time spent writing to disk. At the time of checkpointing, the state may be at least partially stored to the persistent memory, which may functionally serve as storage after the execution of the circuit. If there is sufficient pmem (persistent memory) available, then no disk writing may need to be done at all until after the full simulation of a quantum circuit execution is complete.

C.4 Platform Automation for Dynamic Determination of Checkpoint Time

A further aspect of some embodiments comprises systems and methods that use platform automation to dynamically determine when to checkpoint a circuit. In an embodiment, a platform, such as a platform for execution of quantum circuits for example, may comprise an infrastructure, such as the infrastructure 108 for example. Particularly, a platform may have multiple ML (machine learning) models running, possibly concurrently, and performing various tasks related to execution of quantum circuits. These may include an ML model that operates to determine efficient resource allocation to pods simulating quantum circuits.

Another such ML model may be trained and deployed for the purpose of checkpointing. An embodiment of the service may take in a quantum circuit, such as the circuits 102, 104 and 106, for example, along with circuit metadata such as the number of qubits and the depth of the circuit, and determine where best to insert checkpoints along the simulation of the quantum circuit. This approach may also take into consideration user preferences, such as speed, which may imply fewer checkpoints, or stability, which may imply more checkpoints. That is, execution of the circuit may proceed relatively more quickly if only a few checkpoints are inserted into the circuit, but stability of the circuit may not be optimal. On the other hand, execution of the circuit may proceed relatively more slowly if many checkpoints are inserted into the circuit, but the stability of the circuit may be improved.

Additionally, an ML model according to an embodiment may consider resource factors, such as the existence of persistent memory, in determining when, and how often, to perform a checkpointing process. By taking resource type and availability into account, an embodiment may be able to reduce checkpointing time and, thus, subsidize its use.

C.5 Automated Flattening of Circuit Checkpoint Images

Finally, yet another aspect of one or more embodiments concerns the automated flattening of circuit checkpoint images. By way of comparison with an embodiment of the invention, if a user saves the state of a simulated quantum system during an execution, the user may save the entire state vector object, at least when using qiskit. However, this is a large data structure, containing not only the values of the vector but additional information about the data structure itself. By way of contrast, an embodiment may, when writing state information to memory and/or storage, automatically store only the floating point value entries, which may thus constitute a flattened checkpoint image. Note, for example, that the first two floats A and B may represent the complex value A+Bi as a coefficient of a circuit state/000 . . . 0>. This representation may be relatively small in terms of its storage requirement, and may thus be relatively easy to reverse when the state needs to be read out from storage to resume circuit execution simulation from the checkpoint, by reassembling the float values into the full state vector from which they were obtained.

### D. Example Methods

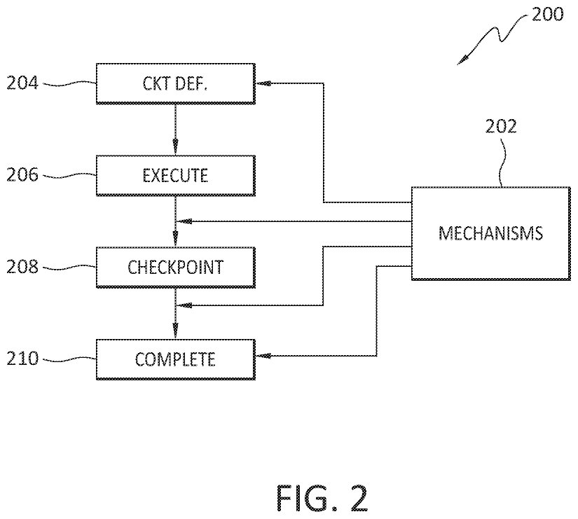

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

With attention now to FIG. 2, a method according to one example embodiment is denoted generally at 200. In an embodiment, the method 200 may performed in whole or in part by, and/or at the direction of, a platform, such as a checkpointing platform, which may comprise an element of, or may include, an infrastructure that may comprise a quantum computing infrastructure and/or a classical computing infrastructure.

In general, one or more aspects of the method 200 may be implemented at any time before, during, and/or after, execution of a quantum circuit. In connection with the example method 200, various mechanisms 202, examples of which are disclosed herein, may be invoked, and/or automatically implemented, at any stage of the method 200.

In an embodiment, the method 200 may begin with definition, or creation, 204 of a quantum circuit that is to be executed on a computing infrastructure. At this stage, a mechanism 202 for including one or more call back gates in the circuit may be invoked, or implemented.

After the circuit has been created 202, possibly including one or more call back gates, execution 206 of the circuit may commence. As noted, execution of the circuit may be implemented on a classical computing infrastructure, or a quantum computing infrastructure.

At some point after execution 206 of the circuit has begun, one or more other of the mechanisms 202 may be implemented. For example, a mechanism 202 may be invoked for determining when checkpointing of the circuit should be performed.

In an embodiment, checkpointing 208 may be performed according to a schedule or scheme specified by the aforementioned checkpointing mechanism 202. Checkpointing 208 may be performed after execution of every gate, at one or more specified times, after execution of only specified gates, or according to any other scheme. In embodiment, a mechanism 202 for persistent memory usage and orchestration may also be implemented in connection with the checkpointing 208. In an embodiment, this particular mechanism 202 may delay writing of circuit state information to memory until after execution of the circuit has been completed 210.

In connection with a checkpointing process 208, the state of the circuit may be captured at various points in time, such as after execution of a gate for example. A mechanism 202 for quantization may be employed in connection with the storage of these states. As well, a mechanism 202 for flattening of circuit checkpoint images may be used in connection with the checkpointing process 208.

At some point, execution of the circuit will complete 210. In an embodiment, a mechanism 202 may operate to write circuit state information to storage after execution has completed 210.

### E. Further Example Embodiments

Following are some further example embodiments of the invention. These are presented only by way of example and are not intended to limit the scope of the invention in any way.

Embodiment 1. A method, comprising: defining a quantum circuit; orchestrating the quantum circuit to a computing infrastructure for execution; executing the quantum circuit on the infrastructure; and while the quantum circuit is being executed, checkpointing the quantum circuit, wherein one of the defining, executing, and checkpointing, comprises using a mechanism that improves and/or enhances performance of the checkpointing.

Embodiment 2. The method as recited in claim 1, wherein the mechanism comprises including a custom call-back gate in the quantum circuit as part of the defining of the quantum circuit, and the custom call-back gate, when executed, performs, or causes the performance of, one or more of: a portion of the checkpointing; collecting telemetry concerning execution of the quantum circuit; and/or acknowledging to a classical computing infrastructure that execution of the quantum circuit has reached a specified point.

Embodiment 3. The method as recited in claim 1, wherein a state of the quantum circuit is captured after execution of a gate of the quantum circuit, and the mechanism comprises using quantization to store the state of the quantum circuit.

Embodiment 4. The method as recited in claim 1, wherein the mechanism comprises using persistent memory and orchestration in the checkpointing, and using the persistent memory comprises at least partly storing a state of the quantum circuit after the checkpointing.

Embodiment 5. The method as recited in claim 1, wherein the mechanism comprises dynamically determining when to perform the checkpointing.

Embodiment 6. The method as recited in claim 5, wherein dynamically determining when to perform the checkpointing comprises balancing a speed of execution of the quantum circuit with a stability of execution of the quantum circuit.

Embodiment 7. The method as recited in claim 1, wherein a state vector of the quantum circuit is captured during the executing, and the mechanism comprises performing automated flattening of the state vector of the quantum circuit.

Embodiment 8. The method as recited in claim 1, wherein the checkpointing comprises performing a respective checkpointing after each gate, in a group of gates of the quantum circuit, is executed.

Embodiment 9. The method as recited in claim 1, wherein the computing infrastructure comprises one or both of, a classical computing infrastructure, and a quantum computing infrastructure.

Embodiment 10. The method as recited in claim 1, wherein the mechanism is employed after execution of the quantum circuit has been completed.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In general, embodiments may comprise classical, and/or quantum, hardware and/or software. Quantum hardware may include, for example, physical qubits and QPUs. Quantum circuits may comprise, for example, real and/or virtual qubits.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

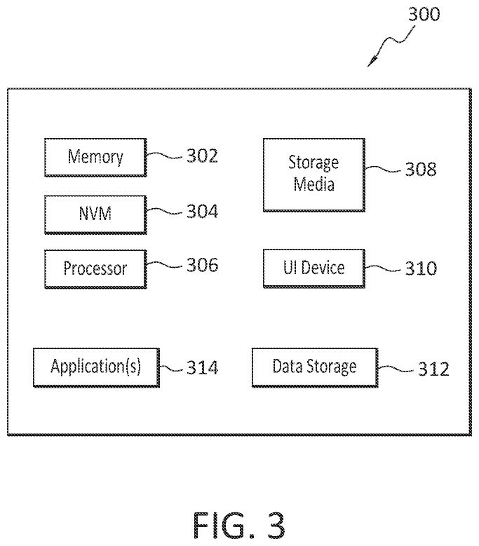

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
defining a quantum circuit;
orchestrating the quantum circuit to a computing infrastructure for execution;
executing the quantum circuit on the infrastructure; and
while the quantum circuit is being executed, checkpointing the quantum circuit,
wherein one of the defining, executing, and checkpointing, comprises using a mechanism that improves and/or enhances performance of the checkpointing.

2. The method as recited in claim 1, wherein the mechanism comprises including a custom call-back gate in the quantum circuit as part of the defining of the quantum circuit, and the custom call-back gate, when executed, performs, or causes the performance of, one or more of: a portion of the checkpointing; collecting telemetry concerning execution of the quantum circuit; and/or acknowledging to a classical computing infrastructure that execution of the quantum circuit has reached a specified point.

3. The method as recited in claim 1, wherein a state of the quantum circuit is captured after execution of a gate of the quantum circuit, and the mechanism comprises using quantization to store the state of the quantum circuit.

4. The method as recited in claim 1, wherein the mechanism comprises using persistent memory and orchestration in the checkpointing, and using the persistent memory comprises at least partly storing a state of the quantum circuit after the checkpointing.

5. The method as recited in claim 1, wherein the mechanism comprises dynamically determining when to perform the checkpointing.

6. The method as recited in claim 5, wherein dynamically determining when to perform the checkpointing comprises balancing a speed of execution of the quantum circuit with a stability of execution of the quantum circuit.

7. The method as recited in claim 1, wherein a state vector of the quantum circuit is captured during the executing, and the mechanism comprises performing automated flattening of the state vector of the quantum circuit.

8. The method as recited in claim 1, wherein the checkpointing comprises performing a respective checkpointing after each gate, in a group of gates of the quantum circuit, is executed.

9. The method as recited in claim 1, wherein the computing infrastructure comprises one or both of, a classical computing infrastructure, and a quantum computing infrastructure.

10. The method as recited in claim 1, wherein the mechanism is employed after execution of the quantum circuit has been completed.

11. A non-transitory storage medium having stored therein instructions that are executable by one or more hardware processors to perform operations comprising:
defining a quantum circuit;
orchestrating the quantum circuit to a computing infrastructure for execution;
executing the quantum circuit on the infrastructure; and
while the quantum circuit is being executed, checkpointing the quantum circuit,
wherein one of the defining, executing, and checkpointing, comprises using a mechanism that improves and/or enhances performance of the checkpointing.

12. The non-transitory storage medium as recited in claim 11, wherein the mechanism comprises including a custom call-back gate in the quantum circuit as part of the defining of the quantum circuit, and the custom call-back gate, when executed, performs, or causes the performance of, one or more of: a portion of the checkpointing; collecting telemetry concerning execution of the quantum circuit; and/or acknowledging to a classical computing infrastructure that execution of the quantum circuit has reached a specified point.

13. The non-transitory storage medium as recited in claim 11, wherein a state of the quantum circuit is captured after execution of a gate of the quantum circuit, and the mechanism comprises using quantization to store the state of the quantum circuit.

14. The non-transitory storage medium as recited in claim 11, wherein the mechanism comprises using persistent memory and orchestration in the checkpointing, and using the persistent memory comprises at least partly storing a state of the quantum circuit after the checkpointing.

15. The non-transitory storage medium as recited in claim 11, wherein the mechanism comprises dynamically determining when to perform the checkpointing.

16. The non-transitory storage medium as recited in claim 15, wherein dynamically determining when to perform the checkpointing comprises balancing a speed of execution of the quantum circuit with a stability of execution of the quantum circuit.

17. The non-transitory storage medium as recited in claim 11, wherein a state vector of the quantum circuit is captured during the executing, and the mechanism comprises performing automated flattening of the state vector of the quantum circuit.

18. The non-transitory storage medium as recited in claim 11, wherein the checkpointing comprises performing a respective checkpointing after each gate, in a group of gates of the quantum circuit, is executed.

19. The non-transitory storage medium as recited in claim 11, wherein the computing infrastructure comprises one or both of, a classical computing infrastructure, and a quantum computing infrastructure.

20. The non-transitory storage medium as recited in claim 11, wherein the mechanism is employed after execution of the quantum circuit has been completed.
